(19) United States
(12) Patent Application Publication
(10) Pub. No.: US 2007/0263291 A1
(43) Pub. Date: Nov. 15, 2007

(54) Micro-hemisphere array fabrication

(75) Inventor: Lorne A. Whitehead, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: The University of British Columbia, Vancouver (CA)

(21) Appl. No.: 11/433,494

(22) Filed: May 15, 2006

(51) Int. Cl. G02B 27/10

(52) U.S. Cl. 359/619

(57) ABSTRACT

A hemi-bead microlens array is provided by forming a transparent seed structure on a transparent substrate then conformally coating the seed structure and the substrate with a transparent coating material having a high refractive index. The seed structure can be a plurality of transparent, high aspect ratio posts uniformly distributed on the substrate. Each post has a height approximately equal to a preselected height value H. Adjacent posts are separated by a distance approximately equal to 2H. The coating material is conformally deposited on the posts and substrate until, for substantially each post, the order of magnitude of the radius of curvature, r, of the coating, at an intersection of the coating on the post with a coated portion of the substrate, equals the order of magnitude of the molecular size of the coating material.

### TECHNICAL FIELD

This disclosure pertains to the fabrication of micro-hemisphere arrays for use in reflective image displays of the type described in U.S. Pat. Nos. 6,885,496 and 6,891,658; and in United States Patent Application Publication No. 2005/0248848A1, all of which are incorporated herein by reference.

### BACKGROUND

FIG. 1A depicts a portion of a prior art reflective (i.e. front-lit) electrophoretically frustrated total internal reflection (TIR) modulated display 10 of the type described in U.S. Pat. Nos. 6,885,496 and 6,891,658. Display 10 includes a transparent outward sheet 12 formed by partially embedding a large plurality of high refractive index (e.g. η₁>˜1.90) transparent spherical or approximately spherical beads 14 in the inward surface of a high refractive index (e.g. η₂>˜1.75) polymeric material 16 having a flat outward viewing surface 17 which viewer V observes through an angular range of viewing directions Y. The “inward” and “outward” directions are indicated by double-headed arrow Z. Beads 14 are packed closely together to form an inwardly projecting monolayer 18 having a thickness approximately equal to the diameter of one of beads 14. Ideally, each one of beads 14 touches all of the beads immediately adjacent to that one bead. Minimal interstitial gaps (ideally, no gaps) remain between adjacent beads.

An electrophoresis medium 20 is maintained adjacent the portions of beads 14 which protrude inwardly from material 16 by containment of medium 20 within a reservoir 22 defined by lower sheet 24. An inert, low refractive index (i.e. less than about 1.35), low viscosity, electrically insulating liquid such as Fluorinert™ perfluorinated hydrocarbon liquid (η₃˜1.27) available from 3M, St. Paul, Minn. is a suitable electrophoresis medium. A bead:liquid TIR interface is thus formed. Other liquids, or water can also be used as electrophoresis medium 20. Medium 20 contains a finely dispersed suspension of light scattering and/or absorptive particles 26 such as pigments, dyed or otherwise scattering/absorptive silica or latex particles, etc. Sheet 24's optical characteristics are relatively unimportant: sheet 24 need only form a reservoir for containment of electrophoresis medium 20 and particles 26, and serve as a support for backplane electrode 48.

As is well known, the TIR interface between two media having different refractive indices is characterized by a critical angle θ_{c}. Light rays incident upon the interface at angles less than θ_{c} are transmitted through the interface. Light rays incident upon the interface at angles greater than θ_{c} undergo TIR at the interface. A small critical angle is preferred at the TIR interface since this affords a large range of angles over which TIR may occur.

In the absence of electrophoretic activity, as is illustrated to the right of dashed line 28 in FIG. 1A, a substantial fraction of the light rays passing through sheet 12 and beads 14 undergoes TIR at the inward side of beads 14. For example, incident light rays 30, 32 are refracted through material 16 and beads 14. The rays undergo TIR two or more times at the bead:liquid TIR interface, as indicated at points 34, 36 in the case of ray 30; and indicated at points 38, 40 in the case of ray 32. The totally internally reflected rays are then refracted back through beads 14 and material 16 and emerge as rays 42, 44 respectively, achieving a “white” appearance in each reflection region or pixel.

A voltage can be applied across medium 20 via electrodes 46, 48 (shown as dashed lines) which can for example be applied by vapour-deposition to the inwardly protruding surface portion of beads 14 and to the outward surface of sheet 24. Electrode 46 is transparent and substantially thin to minimize its interference with light rays at the bead:liquid TIR interface. Backplane electrode 48 need not be transparent. If electrophoresis medium 20 is activated by actuating voltage source 50 to apply a voltage between electrodes 46, 48 as illustrated to the left of dashed line 28, suspended particles 26 are electrophoretically moved into the region where the evanescent wave is relatively intense (i.e. within 0.25 micron of the inward surfaces of inwardly protruding beads 14, or closer). When electrophoretically moved as aforesaid, particles 26 scatter or absorb light, thus frustrating or modulating TIR by modifying the imaginary and possibly the real component of the effective refractive index at the bead:liquid TIR interface. This is illustrated by light rays 52, 54 which are scattered and/or absorbed as they strike particles 26 inside the thin (˜0.5 μm) evanescent wave region at the bead:liquid TIR interface, as indicated at 56, 58 respectively, thus achieving a “dark” appearance in each TIR-frustrated non-reflective absorption region or pixel. Particles 26 need only be moved outside the thin evanescent wave region, by suitably actuating voltage source 50, in order to restore the TIR capability of the bead:liquid TIR interface and convert each “dark” non-reflective absorption region or pixel to a “white” reflection region or pixel.

As described above, the net optical characteristics of outward sheet 12 can be controlled by controlling the voltage applied across medium 20 via electrodes 46, 48. The electrodes can be segmented to control the electrophoretic activation of medium 20 across separate regions or pixels of sheet 12, thus forming an image.

FIG. 2 depicts, in enlarged cross-section, an inward hemispherical or “hemi-bead” portion 60 of one of spherical beads 14. Hemi-bead 60 has a normalized radius r=1 and a refractive index η₁. A light ray 62 perpendicularly incident (through material 16) on hemi-bead 60 at a radial distance a from hemi-bead 60's centre C encounters the inward surface of hemi-bead 60 at an angle θ₁ relative to radial axis 66. For purposes of this theoretically ideal discussion, it is assumed that material 16 has the same refractive index as hemi-bead 60 (i.e. η₁=η₂), so ray 62 passes from material 16 into hemi-bead 60 without refraction. Ray 62 is refracted at the inward surface of hemi-bead 60 and passes into electrophoretic medium 20 as ray 64 at an angle θ₂ relative to radial axis 66.

Now consider incident light ray 68 which is perpendicularly incident (through material 16) on hemi-bead 60 at a distance a_{c}=

$${a}_{c} = \frac{{η}_{3}}{{η}_{1}}$$

from hemi-bead 60's centre C. Ray 68 encounters the inward surface of hemi-bead 60 at the critical angle θ_{c} (relative to radial axis 70), the minimum required angle for TIR to occur. Ray 68 is accordingly totally internally reflected, as ray 72, which again encounters the inward surface of hemi-bead 60 at the critical angle θ_{c}. Ray 72 is accordingly totally internally reflected, as ray 74, which also encounters the inward surface of hemi-bead 60 at the critical angle θ_{c}. Ray 74 is accordingly totally internally reflected, as ray 76, which passes perpendicularly through hemi-bead 60 into the embedded portion of bead 14 and into material 16. Ray 68 is thus reflected back as ray 76 in a direction approximately opposite that of incident ray 68.

All light rays which are incident on hemi-bead 60 at distances a≧a_{c} from hemi-bead 60's centre C are reflected back (but not exactly retro-reflected) toward the light source; which means that the reflection is enhanced when the light source is overhead and slightly behind the viewer, and that the reflected light has a diffuse characteristic giving it a white appearance, which is desirable in reflective display applications. FIGS. 3A, 3B and 3C depict three of hemi-bead 60's reflection modes. These and other modes coexist, but it is useful to discuss each mode separately.

In FIG. 3A, light rays incident within a range of distances a_{c}<a≦a₁ undergo TIR twice (the 2-TIR mode) and the reflected rays diverge within a comparatively wide arc φ₁ centred on a direction opposite to the direction of the incident light rays. In FIG. 3B, light rays incident within a range of distances a₁<a≦a₂ undergo TIR three times (the 3-TIR mode) and the reflected rays diverge within a narrower arc φ₂<φ₁ which is again centred on a direction opposite to the direction of the incident light rays. In FIG. 3C, light rays incident within a range of distances a₂<a≦a₃ undergo TIR four times (the 4-TIR mode) and the reflected rays diverge within a still narrower arc φ₃<φ₂ also centred on a direction opposite to the direction of the incident light rays. Hemi-bead 60 thus has a “semi-retro-reflective,” partially diffuse reflection characteristic, causing display 10 to have a diffuse appearance akin to that of paper.

Display 10 has relatively high apparent brightness, comparable to that of paper, when the dominant source of illumination is behind the viewer, within a small angular range. This is illustrated in FIG. 1B which depicts the wide angular range α over which viewer V is able to view display 10, and the angle β which is the angular deviation of illumination source S relative to the location of viewer V. Display's 10's high apparent brightness is maintained as long as P is not too large. At normal incidence, the reflectance R of hemi-bead 60 (i.e. the fraction of light rays incident on hemi-bead 60 that reflect by TIR) is given by equation (1):

$$R = 1 - {( \frac{{η}_{3}}{{η}_{1}} )}^{2} \qquad ( 1 )$$

where η₁ is the refractive index of hemi-bead 60 and η₃ is the refractive index of the medium adjacent the surface of hemi-bead 60 at which TIR occurs. Thus, if hemi-bead 60 is formed of a lower refractive index material such as polycarbonate (η₁˜1.59) and if the adjacent medium is Fluorinert (η₃˜1.27), a reflectance R of about 36% is attained, whereas if hemi-bead 60 is formed of a high refractive index nano-composite material (η₁˜1.92) a reflectance R of about 56% is attained. When illumination source S (FIG. 1B) is positioned behind viewer V's head, the apparent brightness of display 10 is further enhanced by the aforementioned semi-retro-reflective characteristic.

As shown in FIGS. 4A-4G, hemi-bead 60's reflectance is maintained over a broad range of incidence angles, thus enhancing display 10's wide angular viewing characteristic and its apparent brightness. For example, FIG. 4A shows hemi-bead 60 as seen from perpendicular incidence—that is, from an incidence angle offset 0° from the perpendicular. In this case, the portion 80 of hemi-bead 60 for which a≧a_{c} appears as an annulus. The annulus is depicted as white, corresponding to the fact that this is the region of hemi-bead 60 which reflects incident light rays by TIR, as aforesaid. The annulus surrounds a circular region 82 which is depicted as dark, corresponding to the fact that this is the non-reflective region of hemi-bead 60 within which incident rays are absorbed and do not undergo TIR. FIGS. 4B-4G show hemi-bead 60 as seen from incident angles which are respectively offset 15°, 30°, 45°, 60°, 75° and 90° from the perpendicular. Comparison of FIGS. 4B-4G with FIG. 4A reveals that the observed area of reflective portion 80 of hemi-bead 60 for which a≧a_{c} decreases only gradually as the incidence angle increases. Even at near glancing incidence angles (e.g. FIG. 4F) an observer will still see a substantial part of reflective portion 80, thus giving display 10 a wide angular viewing range over which high apparent brightness is maintained.

Display 10's monolayer 18 may include a large number of non-uniform size “micro-hemispheres” (i.e. hemi-beads 60) having diameters within a range of about 1-50 μm. In order to maximize display 10's reflectance, the shape of each hemi-bead 60 within the micro-hemisphere array comprising monolayer 18 is as close to a mathematically “perfect” hemispherical shape as possible. This disclosure pertains to fabrication of such micro-hemisphere arrays.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1A is a greatly enlarged, not to scale, fragmented cross-sectional side elevation view of a portion of an electrophoretically frustrated or modulated prior art reflective image display.

FIG. 1B schematically illustrates the wide angle viewing range α of the FIG. 1A display, and the angular range β of the illumination source.

FIG. 2 is a greatly enlarged cross-sectional side elevation view of a hemispherical (“hemi-bead”) portion of one of the spherical beads of the FIG. 1A apparatus.

FIGS. 3A, 3B and 3C depict semi-retro-reflection of light rays perpendicularly incident on the FIG. 2 hemi-bead at increasing off-axis distances at which the incident rays undergo TIR two, three and four times respectively.

FIGS. 4A, 4B, 4C, 4D, 4E, 4F and 4G depict the FIG. 2 hemi-bead, as seen from viewing angles which are offset 0°, 15°, 30°, 45°, 60°, 75° and 90° respectively from the perpendicular.

FIGS. 5A, 5B, 5C, 5D, 5E and 5F are greatly enlarged, not to scale, front elevation views depicting sequential fabrication of a portion of a micro-hemisphere array.

FIGS. 6A, 6B and 6C are electron photomicrographs respectively depicting a first sample array of silicone posts, parylene coating applied to the first sample array of silicone posts, and an enlarged view of some of the parylene coated silicone posts in the first sample array.

FIGS. 7A, 7B and 7C are electron photomicrographs respectively depicting a second sample array of silicone posts, parylene coating applied to the second sample array of silicone posts, and an enlarged view of some of the parylene coated silicone posts in the second sample array.

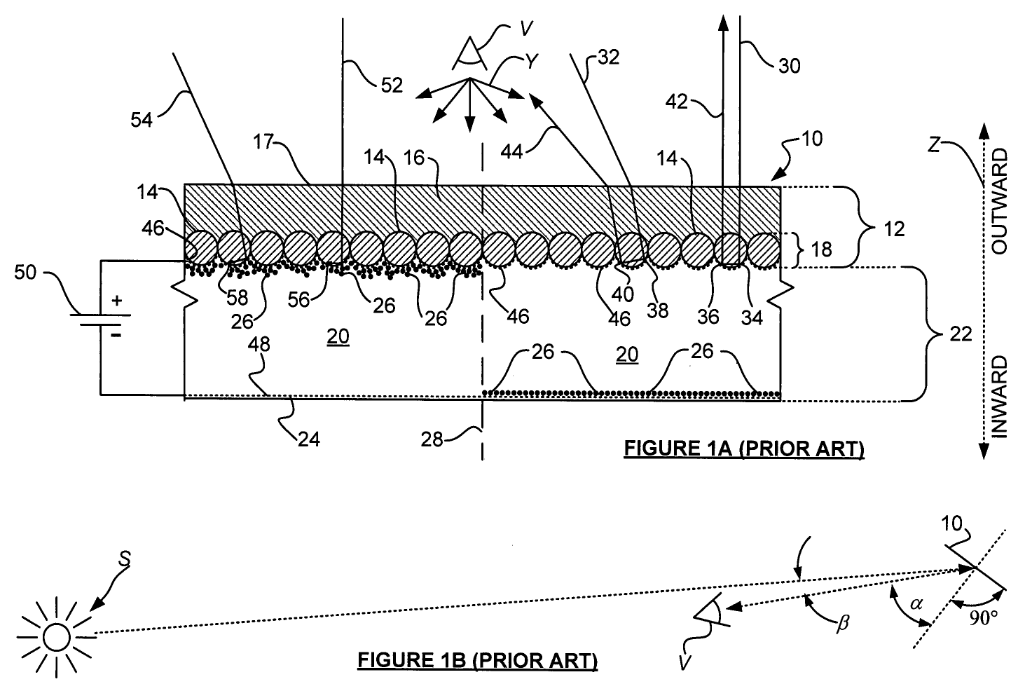

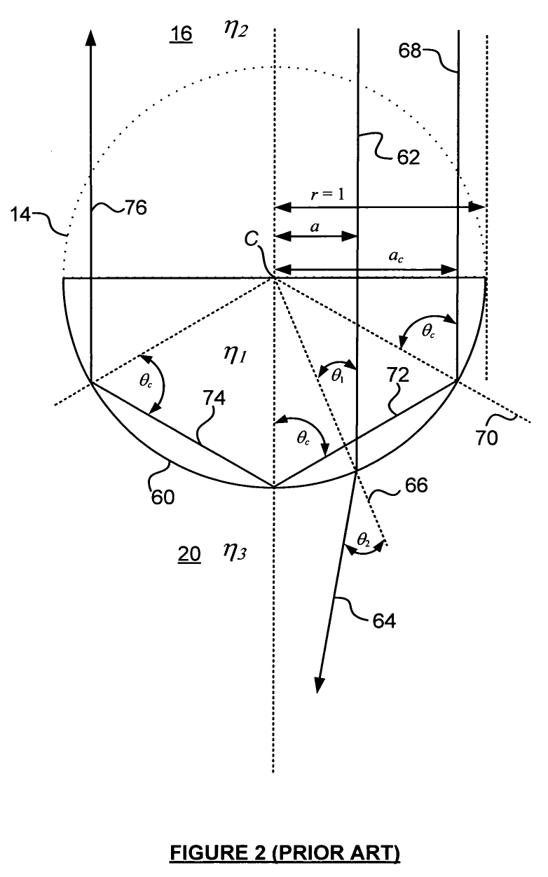

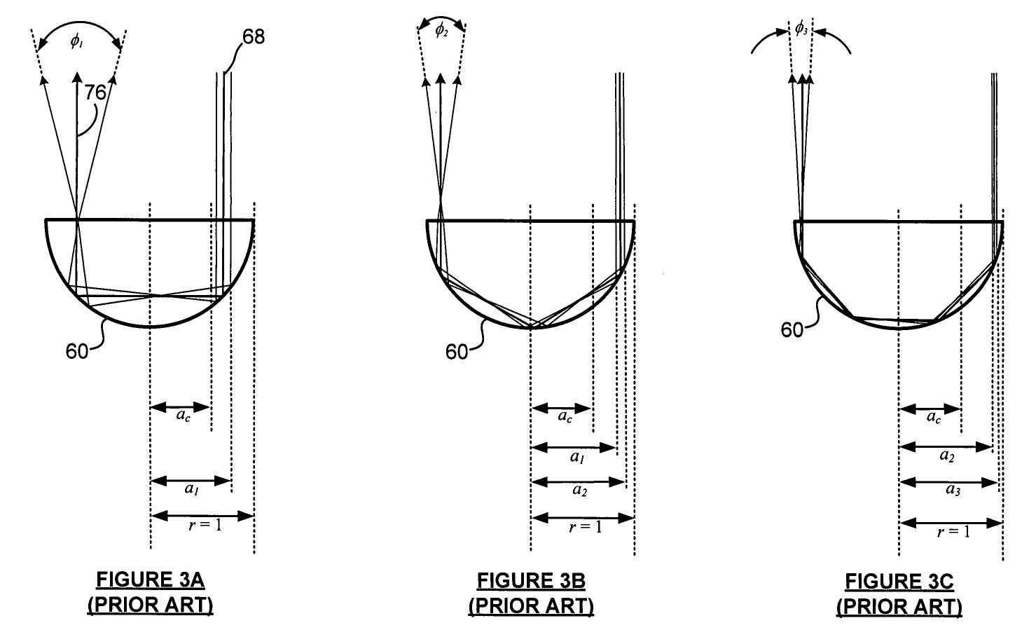

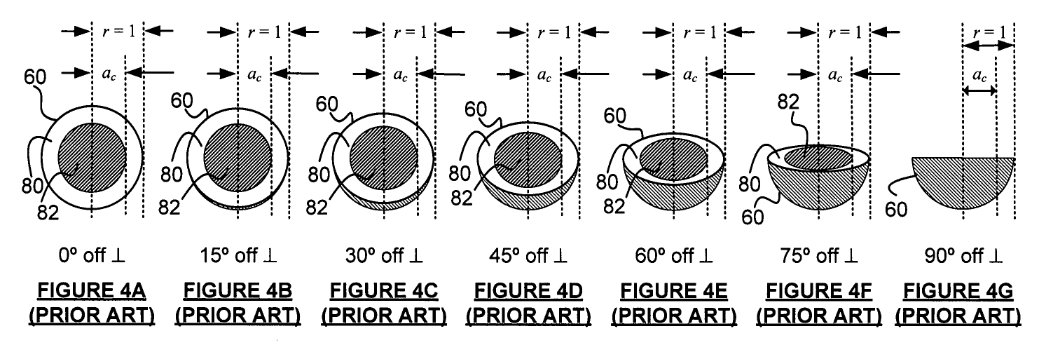

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

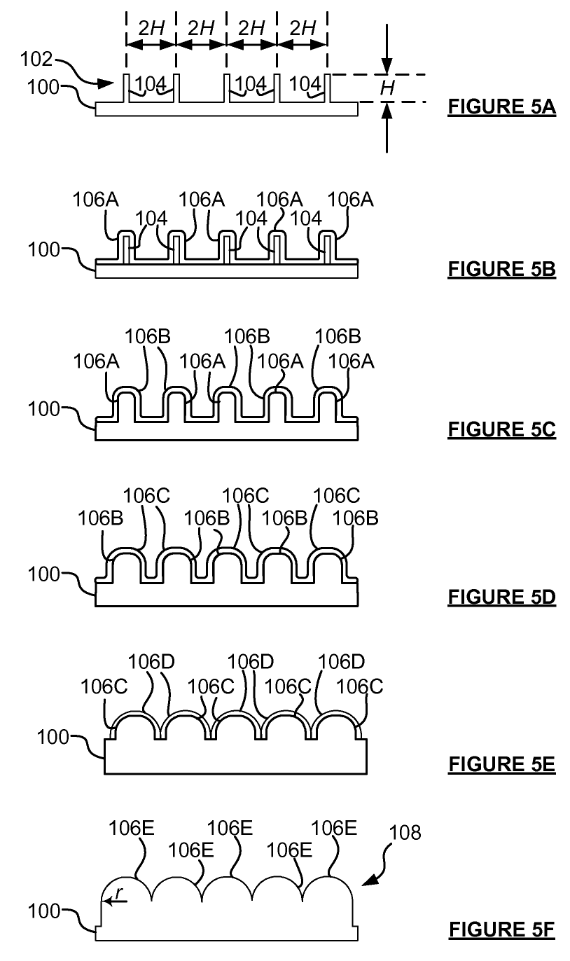

FIG. 5A depicts a transparent substrate 100 on which a transparent seed structure 102 is formed from a moldable material. Seed structure 102 may include a plurality of transparent posts 104 uniformly distributed on substrate 100. Suitable moldable materials include polydimethylsilane, polycarbonate and acrylic.

Substrate 100 and seed structure 102 may be a single unitary structure formed from a single moldable material. Alternatively, substrate 100 and seed structure 102 may each be molded from different materials.

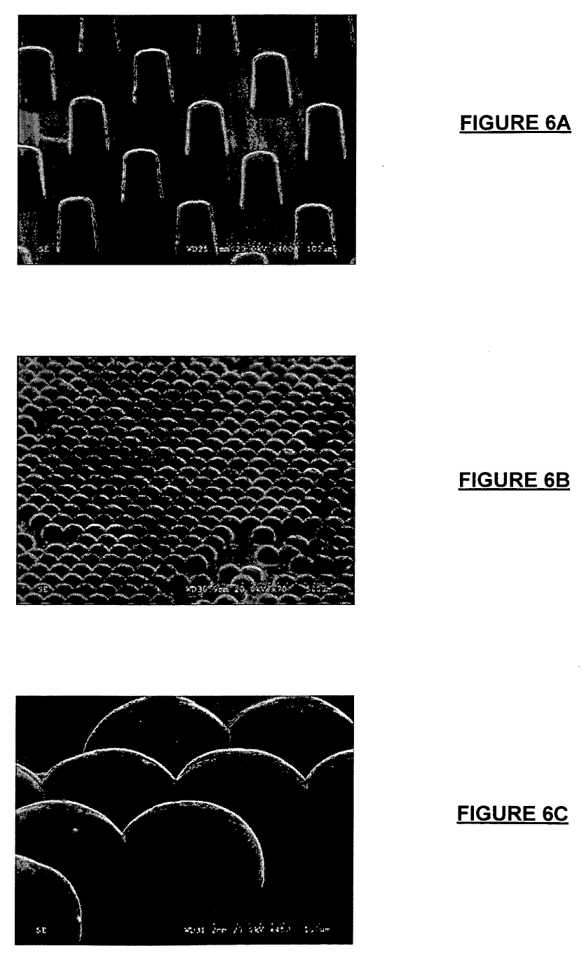

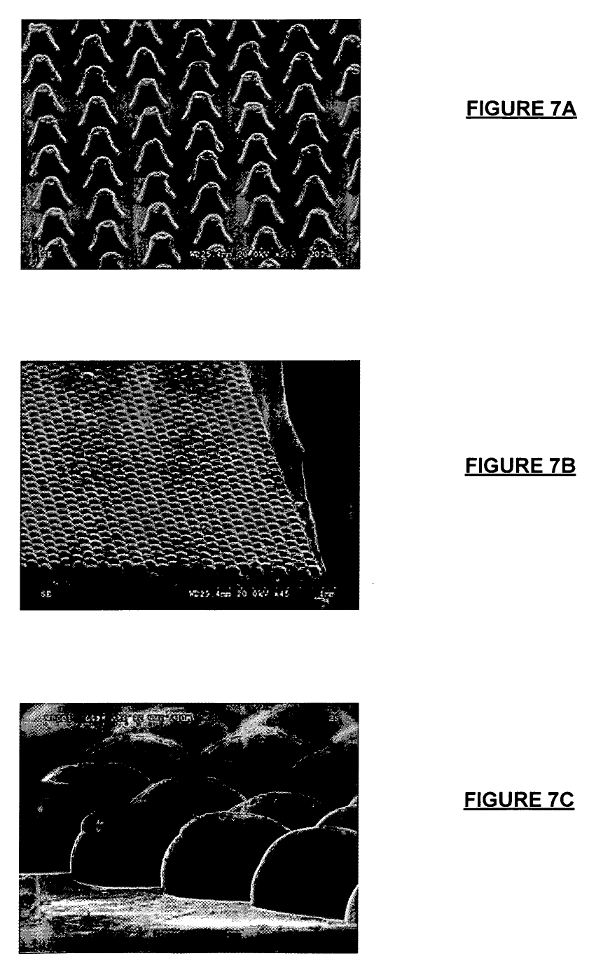

Seed structure 102 may be formed by perforating a layer of a sacrificial material. A moldable material can then be poured or forced into the perforations (depending on the viscosity of the moldable material) and cured. The perforated sacrificial layer is then removed, yielding seed structure 102. FIGS. 6A, 6B, 6C, 7A, 7B and 7C depict structures formed in this manner.

As another example, seed structure 102 may be formed by depositing a layer of high refractive index transparent material on a different transparent substrate material. Portions of the high refractive index material may then be etched away to form posts 104. An anisotropic etching technique is recommended, such that etching progresses more rapidly in directions generally perpendicular to substrate 100 and less rapidly in directions generally parallel to substrate 100, yielding high aspect ratio etched structures (e.g. posts 104). A variety of photolithographic etching techniques, such as deep reactive ion etching, may be used to produce high aspect ratio posts 104.

Posts 104 may have any one of a variety of high aspect ratio shapes, including the tapered cylindrical shape depicted in FIG. 6A, the tapered conical shape depicted in FIG. 7A, and other generally cylindrical or generally conical shapes. Posts 104 may have flat tops as depicted in FIG. 5A, or may have rounded tops as depicted in FIG. 6A, or may have indented tops as depicted in FIG. 7A.

Posts 104 desirably have a relatively high aspect ratio. For example, each post 104 may be about 0.5 microns wide and about 2.5 microns high, yielding an aspect ratio of 5:1, although posts having aspect ratios as low as about 2:1 (as depicted in FIGS. 6A and 7A) are acceptable. Each adjacent pair of posts 104 is desirably separated by a distance approximately equal to twice the height of one post 104. Thus, if the height of each post 104 is approximately equal to a preselected height value H, then each adjacent pair of posts 104 is separated by a distance approximately equal to 2H, as shown in FIG. 5A.

A transparent coating 106A is conformally applied to each post 104 and to substrate 100, as shown in FIG. 5B. The transparent coating material should have a high refractive index, for example a refractive index greater than 1.7. Titanium dioxide, zirconium dioxide and zinc sulphide are examples of suitable coating materials. A variety of conformal coating techniques well known to persons skilled in the art, such as liquid phase deposition, chemical vapour deposition, or sol-gel techniques can be used to conformally coat posts 104 and substrate 100 with transparent coating 106A.

Conformal coating of posts 104 and substrate 100 with a transparent high refractive index coating material is continued, as depicted in FIG. 5C which depicts a thicker coating 106B atop coating 106A. Posts 104 are not shown in FIG. 5C so that other details are not obscured. Comparison of FIGS. 5B and 5C reveals that the shape of coating 106B is more rounded than the underlying coating 106A.

Conformal coating of posts 104 and substrate 100 with transparent high refractive index coating material is continued, as depicted in FIG. 5D which depicts a thicker coating 106C atop coating 106B. Posts 104 are not shown in FIG. 5D so that other details are not obscured. Comparison of FIGS. 5C and 5D reveals that the shape of coating 106C is more rounded than the underlying coating 106B.

Conformal coating of posts 104 and substrate 100 with transparent high refractive index coating material is continued, as depicted in FIG. 5E which depicts a thicker coating 106D atop coating 106C. Posts 104 are not shown in FIG. 5E so that other details are not obscured. Comparison of FIGS. 5D and 5E reveals that the shape of coating 106D is more rounded than the underlying coating 106C.

Conformal coating of posts 104 and substrate 100 with transparent high refractive index coating material is continued, as depicted in FIG. 5F which depicts a thicker coating 106E atop coating 106D. Posts 104 and coating 106D are not shown in FIG. 5F so that other details are not obscured. Comparison of FIGS. 5E and 5F reveals that the shape of coating 106E is more rounded than the underlying coating 106D, with coating 106E constituting the desired final substantially hemispherical shape which hemispherically surrounds each post 104, to yield the desired microlens array 108. The radial thickness of the coating on each post 104, in a notional plane substantially coplanar with substrate 100, is approximately equal to the posts' height H.

The transparent high refractive index coating material may be applied continuously to conformally coat posts 104 and substrate 100, rather than being applied in a series of discrete layers. The coating material may alternatively be applied in discrete layers to conformally coat posts 104 and substrate 100, if desired or convenient.

A conformal coating process which produces sharp internal (i.e. concave) corners with a radius of curvature that becomes very small (approaching molecular dimensions) is recommended. Thus, as coating progresses, the coating gradually and conformally accumulates, with the coating on each post forming a concave surface having a radius of curvature, r (FIG. 5E), at the intersection of the coating on each post 104 with the coating on substrate 100. r gradually decreases as the coating thickness increases. Thus, the internal (i.e. concave) corners of the coating on each post 104 initially have a finite but small radius of curvature, r, which “sharpens” such that r approaches zero as the coating thickness increases, as seen in FIGS. 6C nd 7C. When the coating process concludes, the order of magnitude of r at the intersection of the coating on each post 104 with coated substrate 100, desirably equals the order of magnitude of the molecular size of the coating material. For example, titanium dioxide has a molecular size of about 1-10 nm, implying an order of magnitude value for r of 1.

While a number of exemplary aspects and embodiments have been discussed above, those of skill in the art will recognize certain modifications, permutations, additions and sub-combinations thereof. For example, the coating process can be calibrated by experimentally determining final time, temperature, pressure and other process parameters characteristic of acceptable microlens arrays. Such parameters, or suitable combinations thereof, can be monitored as the coating process progresses and the process can be stopped when the monitored parameters attain values acceptably close to values previously determined to characterize acceptable microlens arrays. It is intended that the following appended claims and claims hereafter introduced are interpreted to include all such modifications, permutations, additions and sub-combinations as are within their true spirit and scope.

What is claimed is:

1. A microlens array, comprising:
a transparent substrate;
a transparent seed structure on the substrate; and
a transparent conformal coating on the seed structure and on the substrate.

2. A microlens array as defined in claim 1, wherein the seed structure further comprises a moldable material.

3. A microlens array as defined in claim 1, wherein the coating further comprises a material having a refractive index greater than 1.7.

4. A microlens array as defined in claim 2, wherein the coating further comprises a material having a refractive index greater than 1.7.

5. A microlens array as defined in claim 1, wherein:
the seed structure further comprises a plurality of transparent, high aspect ratio posts uniformly distributed on the substrate; and
the coating conformally coats each one of the posts and the substrate.

6. A microlens array as defined in claim 5, wherein:
each one of the posts has a height approximately equal to a preselected height value H;
the seed structure further comprises a moldable material; and
the radial thickness of the coating on each one of the posts, in a notional plane substantially coplanar with the substrate, is approximately equal to H.

7. A microlens array as defined in claim 6, wherein adjacent ones of the posts are separated by a distance approximately equal to 2H.

8. A microlens array as defined in claim 7, wherein the coating further comprises titanium dioxide.

9. A microlens array as defined in claim 7, wherein:
the coating on each one of the posts has a curved portion forming an intersection with a coated portion of the substrate, the curved portion having a radius of curvature at the intersection;
the coating further comprising a material having a molecular size; and
the radius of curvature at the intersection having an order of magnitude equal to an order of magnitude of the molecular size of the coating material.

10. A microlens array as defined in claim 2, wherein:
the seed structure further comprises a plurality of transparent, high aspect ratio posts uniformly distributed on the substrate; and
the coating conformally coats each one of the posts.

11. A microlens array as defined in claim 10, wherein:
each one of the posts has a height approximately equal to a preselected height value H;
the seed structure further comprises a moldable material; and
the radial thickness of the coating on each one of the posts, in a notional plane substantially coplanar with the substrate, is approximately equal to H.

12. A microlens array as defined in claim 11, wherein adjacent ones of the posts are separated by a distance approximately equal to 2H.

13. A microlens array as defined in claim 12, wherein the coating further comprises titanium dioxide.

14. A microlens array as defined in claim 11, wherein:
the coating on each one of the posts has a curved portion forming an intersection with a coated portion of the substrate, the curved portion having a radius of curvature at the intersection;
the coating further comprising a material having a molecular size; and
the radius of curvature at the intersection having an order of magnitude equal to an order of magnitude of the molecular size of the coating material.

15. A microlens array as defined in claim 3, wherein:
the seed structure further comprises a plurality of transparent, high aspect ratio posts uniformly distributed on the substrate; and
the coating conformally coats each one of the posts.

16. A microlens array as defined in claim 15, wherein:
each one of the posts has a height approximately equal to a preselected height value H;
the seed structure further comprises a moldable material; and
the radial thickness of the coating on each one of the posts, in a notional plane substantially coplanar with the substrate, is approximately equal to H.

17. A microlens array as defined in claim 16, wherein adjacent ones of the posts are separated by a distance approximately equal to 2H.

18. A microlens array as defined in claim 17, wherein the coating further comprises titanium dioxide.

19. A microlens array as defined in claim 17, wherein:
the coating on each one of the posts has a curved portion forming an intersection with a coated portion of the substrate, the curved portion having a radius of curvature at the intersection;
the coating further comprising a material having a molecular size; and
the radius of curvature at the intersection having an order of magnitude equal to an order of magnitude of the molecular size of the coating material.

20. A microlens array as defined in claim 4, wherein:
the seed structure further comprises a plurality of transparent, high aspect ratio posts uniformly distributed on the substrate; and
the coating conformally coats each one of the posts.

21. A microlens array as defined in claim 20, wherein:
each one of the posts has a height approximately equal to a preselected height value H;
the seed structure further comprises a moldable material; and
the radial thickness of the coating on each one of the posts, in a notional plane substantially coplanar with the substrate, is approximately equal to H.

22. A microlens array as defined in claim 21, wherein adjacent ones of the posts are separated by a distance approximately equal to 2H.

23. A microlens array as defined in claim 22, wherein the coating further comprises titanium dioxide.

24. A microlens array as defined in claim 21:
the coating on each one of the posts has a curved portion forming an intersection with a coated portion of the substrate, the curved portion having a radius of curvature at the intersection;
the coating further comprising a material having a molecular size; and
the radius of curvature at the intersection having an order of magnitude equal to an order of magnitude of the molecular size of the coating material.

25. A microlens array as defined in claim 1, wherein the coating on the seed structure has a substantially hemispherical shape.

26. A microlens array as defined in claim 1, wherein the coating hemispherically surrounds the seed structure.

27. A microlens array as defined in claim 5, wherein the coating on each one of the posts has a substantially hemispherical shape.

28. A microlens array as defined in claim 5, wherein the coating hemispherically surrounds each one of the posts.

29. A method of making a microlens array, the method comprising:
forming an transparent seed structure on a transparent substrate; and
conformally depositing a transparent coating onto the seed structure.

30. A method as defined in claim 29, wherein the seed structure has a preselected shape.

31. A method as defined in claim 29, further comprising forming the seed structure from a moldable material.

32. A method as defined in claim 29, further comprising forming the coating from a material having a refractive index greater than 1.7.

33. A method as defined in claim 29, further comprising:
forming the seed structure as a plurality of transparent, high aspect ratio posts;
uniformly distributing the posts on the substrate; and
conformally depositing the coating on each one of the posts.

34. A method as defined in claim 33, wherein:
each one of the posts has a height approximately equal to a preselected height value H; and
the radial thickness of the coating on each one of the posts, in a notional plane substantially coplanar with the substrate, is approximately equal to H.

35. A method as defined in claim 34, further comprising uniformly distributing the posts on the substrate such that adjacent ones of the posts are separated by a distance approximately equal to 2H.

36. A method as defined in claim 33, further comprising conformally depositing the coating on each one of the posts until, for substantially each one of the posts, the order of magnitude of the radius of curvature of the coating, at an intersection of the coating on the post with a coated portion of the substrate, equals the order of magnitude of the molecular size of the coating material.
